(19) United States
(12) Patent Application Publication
(10) Pub. No.: US 2006/0277268 A1
(43) Pub. Date: Dec. 7, 2006

(54) Access method for file systems

(76) Inventor: Craig F. Everhart, Chapel Hill, NC (US)

Correspondence Address: LIEBERMAN & BRANDSDORFER, LLC, 802 STILL CREEK LANE, GAITHERSBURG, MD, 20878, US

(21) Appl. No.: 11/142,970

(22) Filed: Jun. 2, 2005

(51) Int. Cl. G06F 15/16

(52) U.S. Cl. 709/217

(57) ABSTRACT

Multiple data access techniques are communicated to a client machine requesting access to a shared resource. In response to the returned techniques, the client machine may select one technique for accessing the shared resource. Although the client machine may implement one or more of the techniques to read or write data to the shared resource, different techniques may be preferable based upon protection and privacy associated with the access. A method for the client machine selecting a preferred data access technique may be based upon a topological relationship of the client machine to data storage or a server selected technique.

### BACKGROUND OF THE INVENTION

1. Technical Field

This invention relates to a method and system for data access by a client machine in a client-server system. More specifically, the method and system communicate multiple options to a client machine for accessing data.

2. Description of the Prior Art

FIG. 1 is a prior art block diagram (10) of a distributed file system including a server cluster (20), a plurality of client machines (12), (14), and (16), and a storage area network (SAN) (30). Each of the client machines communicate with one or more server machines (22), (24), and (26) over a data network (40). Similarly, each of the client machines (12), (14), and (16) and each of the server machines in the server cluster (20) are in communication with the storage area network (30). The storage area network (30) includes a plurality of shared disks (32) and (34) that contain only blocks of data for associated files. Similarly, the server machines (22), (24), and (26) contain only metadata pertaining to location and attributes of the associated files. Each of the client machines may access an object or multiple objects stored on the file data space of the SAN (30), but may not access the metadata space. In opening the contents of an existing file object on the storage media in the SAN (30), a client machine contacts one of the server machines to obtain metadata and locks. Metadata supplies the client machine with information about a file, such as its attributes and location on storage devices. Locks supply the client machine with privileges it needs to open a file and read or write data. The server machine performs a look-up of metadata information for the requested file within metadata space of the SAN (30). The server machine communicates granted lock information and file metadata to the requesting client machine, including the location of all data blocks making up the file. Once the client machine holds a lock and knows the data block location(s), the client machine can access the data for the file directly from a shared storage device attached to the SAN (30).

As shown in FIG. 1, the illustrated distributed file system separately stores metadata and data. Metadata, including the location of blocks of each file on shared storage, are maintained on high performance storage at the server machines (22), (24), and (26). The shared disks (32) and (34) contain only blocks of data for the files. This distribution of metadata and data enables optimization of data traffic on the shared disks (32) and (34) of the SAN (30), and optimization of the metadata workload. The SAN environment offloads the distributed file system servers by removing their data tasks.

Using FIG. 1 as an illustrative example, the server cluster has a repository of storage media that it shares access thereto with the client machine. The data repository is a storage device that is used by the server as a source for data to be read and as a source to store written data. In a file system that supports third party transfer of data, the server shares the data repository with the client machine. In response to a read request, the server communicates the location of requested data to the client machine, and the client machine reads the data from the data repository. Similarly, in response to a write request, the client machine asks the server for data blocks in which it can write data, and the server responds with data blocks addresses. The client machine uses its connection to the data repository to write the data to the assigned block addresses.

There are at least three known techniques of data access by a client machine in a client-server file system. One data access technique is known as a block direct access that provides storage address identifiers to the client machine in response to a data access request. There is minimal protection and privacy associated with this transaction. A second data access technique is known as object direct access, users of which include an object identifier along with other information for addressing back end storage. This technique provides more security than the block direct access technique in that the capability to access blocks of data is indirectly provided, i.e. indirect access. A third data access technique, and the most secure known technique, is through a file server. This technique has the most security since the client machine is not provided with block address identifiers, rather the client machine is provided with the data through the server. Although there are several known techniques of accessing data, different techniques may be preferably employed depending upon different characteristics associated with the data access request.

FIG. 2 is a prior art flow chart (100) illustrating communication between a client machine and a server demonstrating a data access request utilizing the block diagram shown in FIG. 1. A client machine sends a data access request to a server in a client-server file system (102). In response to the data access request at step (102), the server returns metadata to the requesting client machine for use with a single data access technique, i.e. block direct access, object direct access, and access through a file server (104). Upon receipt of the data access technique, the client machine tries to implement the data access technique (106). Thereafter, a test is conducted to determine if the client machine was successful in accessing the data with the returned data access technique (108). A positive response to the test at step (108) will result in completion of the data access request (110). However, a negative response to the test at step (108) will result in the client machine sending a data request to the server (112), followed by the server returning data to the client machine (114). Accordingly, as shown herein, the client machine is provided a single data access technique in response to a request, and if the returned technique does not provide the client machine with the request data, the client machine sends a communication to the server to return the requested data.

However, there are limitations associated with the prior art method of data communication in a client-server file system. One limitation in the prior art is its limitation to return a single data access technique to the client machine to read or write the data. For example, in a client-server file system with multiple client machines some client machines may have a local connection to a storage device and other client machines may have a remote connection to a storage device. The server may dictate that it is beneficial for the client machine with the local connection to utilize a different data access protocol than the client machine with the remote connection, as different data access protocols have different security mechanisms. Accordingly, it is desirable to provide a method that supports communication of multiple client driven data access techniques to a requesting client machine while considering flexibility and security associated with data access.

### SUMMARY OF THE INVENTION

This invention comprises a method and system that supports enhancing flexibility associated with data access requests in a client-server file system.

In one aspect of the invention, a method is provided for directing access of data. A first data access request is received from a client machine for a client driven access technique. In response to the data access request, multiple architectural techniques are returned to the requesting client machine for accessing the requested data.

In another aspect of the invention, a computer system is provided with a client machine in communication with a server. A first data access request is communicated from the client machine to the server for a client driven access technique. In response to the first data access request, multiple client driven communication techniques are returned to the client machine.

In yet another aspect of the invention, an article is provided with in a computer-readable signal-bearing medium. Means in the medium are provided for receiving a first data access request from a client machine for a client driven access technique. In response to the first data access request, means in the medium are provided for returning multiple architectural techniques to the client machine for accessing the requested data responsive to said first data access request.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a block diagram of a prior art distributed file system.

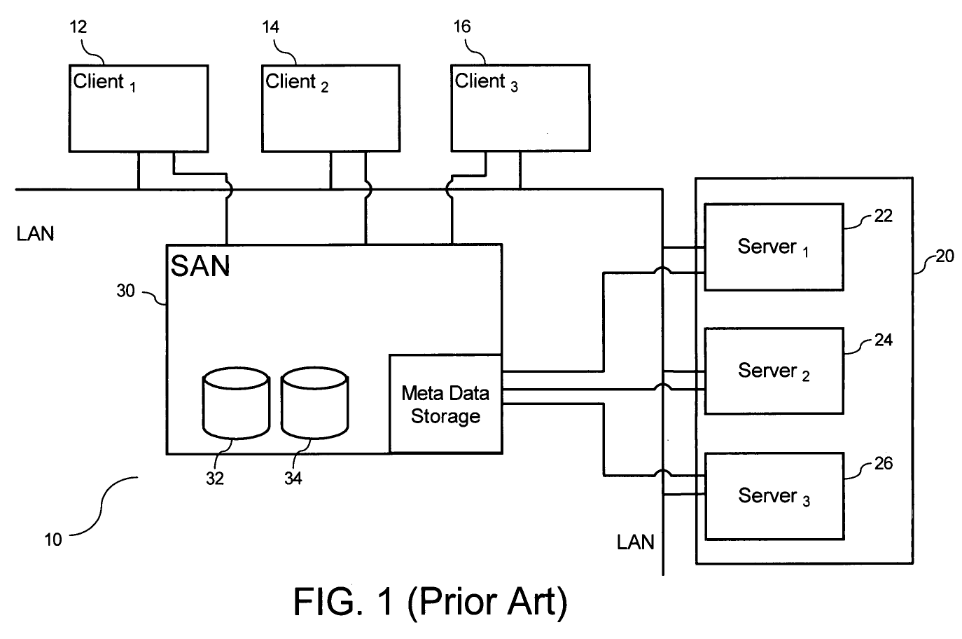

FIG. 2 is a flow chart of a prior art method of communicating a data access technique in a distributed file system.

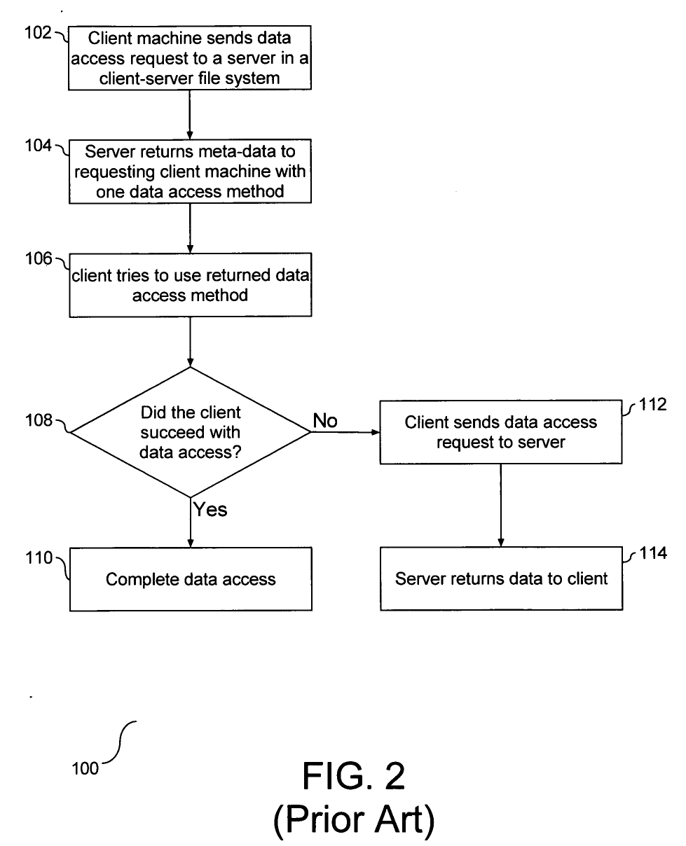

FIG. 3 is a flow chart of a method of communicating multiple data access techniques in a client-server system according to the preferred embodiment of this invention, and is suggested for printing on the first page of the issued patent.

### DESCRIPTION OF THE PREFERRED EMBODIMENT

### Overview

As noted, there are at least three known techniques of data access by a client machine in a client-server file system. Different techniques may be employed depending upon different characteristics associated with the data access request. Authority is shifted from the server to the client machine to select an optimal technique by communicating multiple data access techniques in response to a data access request.

### Technical Details

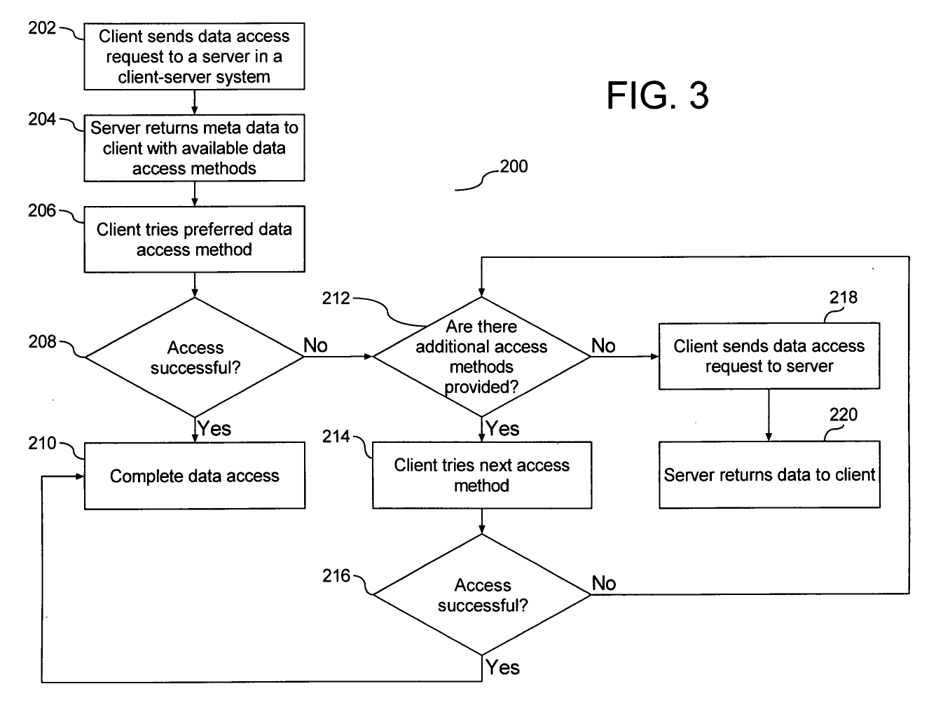

FIG. 3 is a block diagram (200) illustrating a method of returning multiple data access techniques to a client machine in a client-server system in response to a data access request. Initially, the client machine sends a data access request to a server machine in a client-server system (202). The server responds to the client machine by returning metadata to the client machine useable with available data access techniques (204). Three known data access techniques include block direct access, object direct access, and access through the file server. The client machine then tries the preferred data access technique based upon its internal categorization (206). Following a client data access request, the client machine determines if the data access attempt was successful through the available access technique (208). A positive response to the test at step (208) will result in completion of the data access request (210). However, a negative response to the test at step (208) will result in the client machine conducting a subsequent test (212) to determine if there are additional access techniques that were returned by the server at step (204). A positive response to the test at step (212) results in the client machine trying the next data access technique available based upon its hierarchical categorization (214). Similar to step (208), the client machine conducts a test to determine if the client machine successfully accessed the data through the available access technique (216). A positive response to the test at step (216) will result in completion of the data access request (210), and a negative response to the test at step (216) will cause a return to step (212). A negative response to the test at step (212) will result in the client machine sending a data request to the server (218), followed by the server performing the data access on behalf of the client machine and returning the result to the client machine (220). In a case of a read operation, the result to the client machine at step (220) will include the data that has been read. Similarly, in a write operation, the storage access performed by the client machine at step (220) will include the data to be written to the storage. Accordingly, as shown herein, the client machine is provided one or more client driven data access techniques by the server in response to a request thereby removing the requirement that the server must know how the client is connected to the data.

As shown in FIG. 3, the client machine may categorize the returned client driven data access techniques and/or place them into a hierarchical organization. When the categorization is based upon a topological relationship of the client machine to the storage, the categorization determines the preferred access technique. Since there are different factors that may determine how to categorize the data access technique, the topological relationship of the client machine making the data access request and the location of the data may indicate only one criterion for categorizing the returned techniques. Regardless of the categorization, the client machine initiates data access through one or more of the returned client driven techniques.

The method and system for returning multiple data access techniques to a client machine provides the client machine with flexibility in selecting an optimal technique.

The method for request data access techniques may be invoked in the form of a tool utilized by the client machine to communicate with the sever. The tool may include a data access request, or a request manager to facilitate communication with the server, and a returned of one or more data access techniques for use by the client machine to access data from storage media. In one embodiment, the data access request or request manager may be stored on a computer-readable medium as it contains data in a machine readable format. Similarly, the data access technique(s) returned by the server for use by the client machine may also be embedded in a machine readable format to support communication among the client machine, the server, and the storage media. Accordingly, the data access request, request manager, and data access technique(s) may all be in the form of hardware elements in the computer system or software elements in a computer-readable format or a combination of software and hardware.

### Advantages Over The Prior Art

In response to a data access request, the server communicates one or more data access techniques to a requesting client machine. Upon receipt of the communication, the client machine determines a preferred access technique. Such a determination may be based upon different protocols. For example, the determination may be based upon a topological relationship of the client machine to the data storage. Similarly, the determination may also be based upon a server selected technique. In a file system architecture in which some client machines have a local connection to data storage and other client machines have a more distant connection to data storage, the return of multiple access techniques to the client machines enables the client machines to select the optimal technique.

### Alternative Embodiments

It will be appreciated that, although specific embodiments of the invention have been described herein for purposes of illustration, various modifications may be made without departing from the spirit and scope of the invention. In particular, based upon select criteria the client machine categorizes the returned data access techniques in a hierarchical format. Accordingly, the scope of protection of this invention is limited only by the following claims and their equivalents.

We claim:

1. A method for directing access of data comprising:
receiving a first data access request from a client machine for a client driven access technique; and
returning multiple architectural techniques to said client machine for accessing said requested data responsive to said first data access request.

2. The method of claim 1, further comprising said requesting client machine selecting a preferred client driven data access technique from said returned access techniques.

3. The method of claim 2, further comprising said requesting client machine selecting an alternative returned client driven data access technique in response to an unsuccessful data access through said preferred data access technique.

4. The method of claim 3, further comprising receiving a second data access request from the client in response to an unsuccessful data access through each of said returned multiple techniques and satisfying that data access request on behalf of the client.

5. The method of claim 2, wherein the step of selecting a preferred data access technique is based upon a topological relationship of said client machine to data storage.

6. The method of claim 2, wherein the step of selecting a preferred data access technique is based upon a server selected technique.

7. A computer system comprising:
a client machine in communication with a server;
a first data access request adapted to be communicated from said client machine to said server for a client driven data access technique; and
multiple client driven communication techniques returned to said client machine in response to said first data access request.

8. The system of claim 7, further comprising a preferred client driven data access technique adapted to be selected by said client machine from said returned techniques.

9. The system of claim 8, further comprising an alternative returned client driven data access technique adapted to be selected by said client machine responsive to an unsuccessful data access through said preferred data access technique.

10. The system of claim 9, further comprising a second data access request adapted to be communicated to said server responsive to unsuccessful data access through each of said returned techniques.

11. The system of claim 8, wherein selection of said preferred data access technique is based upon a topological relationship of said client machine to data storage.

12. The system of claim 8, wherein selection of said preferred data access technique is based upon a server selected technique.

13. An article comprising:
a computer-readable signal-bearing medium;
means in the medium for receiving a first data access request from a client machine for a client driven access technique; and
means in the medium for returning multiple architectural techniques to said client machine for accessing said requested data responsive to said first data access request.

14. The article of claim 13, wherein the medium is selected from a group consisting of: a recordable data storage medium, and a modulated carrier signal.

15. The article of claim 13, further comprising means in the medium for said requesting client machine to select a preferred client driven data access technique from said returned access techniques.

16. The article of claim 15, further comprising means in the medium for said requesting client machine to select an alternative returned client driven data access technique in response to an unsuccessful data access through said preferred data access technique.

17. The article of claim 16, further comprising means in the medium for receiving a second data access request from said client in response to an unsuccessful data access through each of said returned multiple techniques and satisfying that data access request on behalf of the client.

18. The article of claim 15, wherein the means for selecting a preferred data access technique is based upon a topological relationship of said client machine to data storage.

19. The article of claim 15, wherein the means for selecting a preferred data access technique is based upon a server selected technique.
